(19) United States
(12) Patent Application Publication
(10) Pub. No.: US 2014/0149322 A1
(43) Pub. Date: May 29, 2014

(54) Protecting Contents in a Content Management System by Automatically Determining the Content Security Level

(71) Applicant: INTERNATIONAL BUSINESS MACHINES CORPORATION, Armonk, NY (US)

(72) Inventors: Jason D. LaVoie, Littleton, MA (US); David D. Taieb, Charlestown, MA (US)

(73) Assignee: INTERNATIONAL BUSINESS MACHINES CORPORATION, Armonk, NY (US)

(21) Appl. No.: 13/686,111

(22) Filed: Nov. 27, 2012

(51) Int. Cl. G06N 5/02; G06N 99/00

(52) U.S. Cl. CPC G06N 5/02; G06N 99/005
USPC 706/12; 706/46

(57) ABSTRACT

An approach is provided to automatically classify and handle data. The approach is implemented by an information handling system. In the approach, data is received, from a sender, at a content management system. When the data is received, the system automatically utilizes an artificial intelligence (AI) engine (e.g., IBM Watson, etc.) to perform an unstructured information analysis using a pre-existing knowledge base. The result of using the AI engine is an identification of a confidentiality level of the data. The approach further performs an action based on the identified confidentiality level of the data.

### TECHNICAL FIELD

The present disclosure relates to an approach that utilizes an artificial intelligence system to identify and protect sensitive document data.

### BACKGROUND OF THE INVENTION

In today's networked computing environment, adequately protecting sensitive (e.g., confidential, etc.) content found in documents is an increasingly daunting challenge facing many enterprises. Determining and enforcing the correct level of access control for classified content is typically a manual process subject to human error. Rapid advancements in telecommunications, computing hardware and software, and data encryption have led to a proliferation of relatively powerful computer systems. The availability of smaller, more powerful and less expensive computer systems made electronic data processing within the reach of small business and the home user. These computers quickly became interconnected through networks, such as the Internet. The rapid growth and widespread use of electronic data processing and electronic business conducted through the Internet increases the need for better methods of protecting the computers and the information they store, process and transmit.

IBM Watson, (or “Watson”) is an artificial intelligence computer system capable of answering questions posed in natural language. Watson is a workload optimized system designed for complex analytics, made possible by integrating massively parallel POWER7 processors and the IBM DeepQA software to answer natural language questions. In the television game show “Jeopardy!,” Watson answered natural language questions in under three seconds. At the time of the Jeopardy! competition, Watson was made up of a cluster of ninety IBM Power 750 servers (plus additional I/O, network and cluster controller nodes in 10 racks) with a total of 2880 POWER7 processor cores and 16 Terabytes of RAM. Each Power 750 server uses a 3.5 GHz POWER7 eight core processor, with four threads per core. The POWER7 processor's massively parallel processing capability is well matched for Watson's IBM DeepQA software which is “embarrassingly parallel” (with a workload that is easily split into multiple parallel tasks). Watson can process 500 gigabytes, the equivalent of a million books, per second.

### SUMMARY

An approach is provided to automatically classify and handle data. The approach is implemented by an information handling system. In the approach, data is received, from a sender, at a content management system. When the data is received, the system automatically utilizes an artificial intelligence (AI) engine (e.g. IBM Watson, etc.) to perform advanced language processing on unstructured information using, for example but not limited to, the Unstructured Information Management Architecture framework (UIMA). The result of using the AI engine is an identification of a confidentiality level of the data. The approach further performs an action based on the identified confidentiality level of the data.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in evaluating documents and determining appropriate actions to take based on confidential information found in the documents;

FIG. 4 is a depiction of a flowchart showing the logic used in an artificial intelligence (AI) deep question/answer (QA) pipeline to identify confidential data in documents; and

FIG. 5 is a depiction of a flowchart showing the logic used in the confidential document handling agent.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

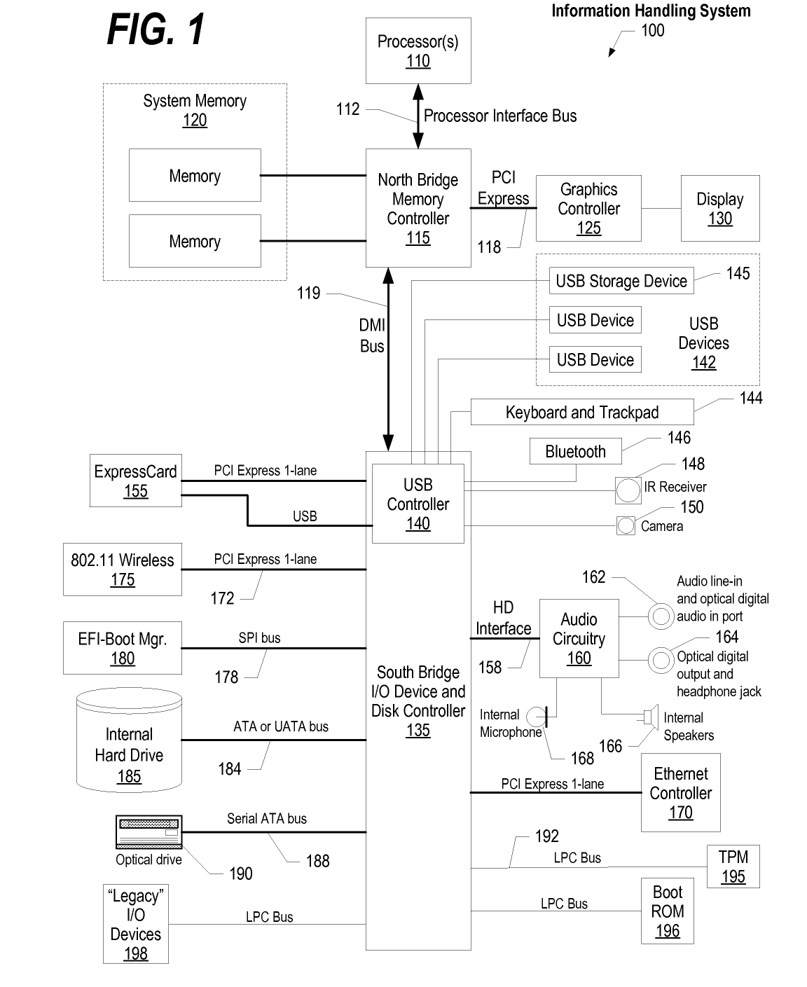

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

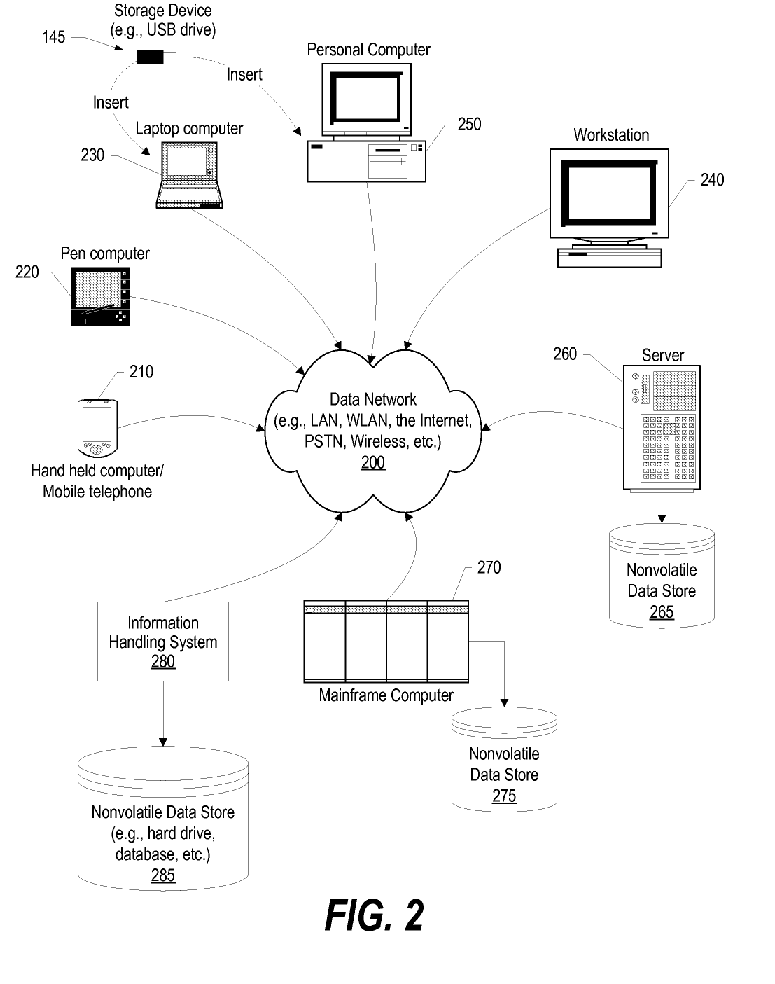

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

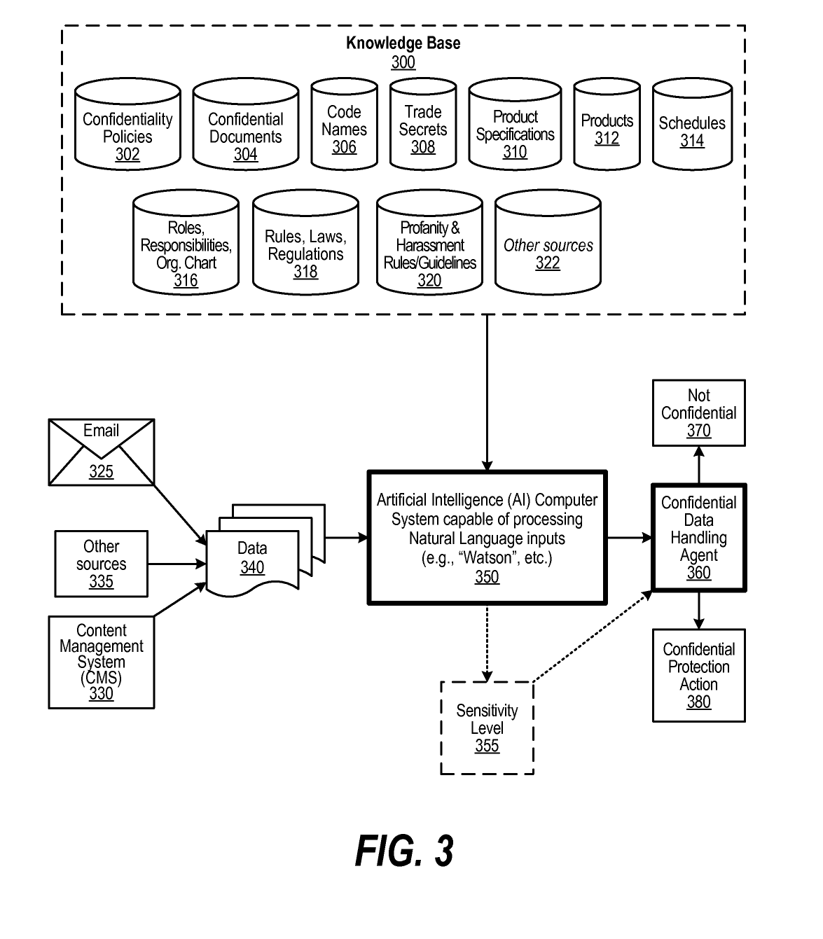

FIGS. 3-5 depict an approach that can be executed on an information handling system and computer network as shown in FIGS. 1-2. This approach automates the identification of confidential, or sensitive, data in an organization and further automates performance of certain actions based on the identified sensitivity level. At its core, the approach describes a process with the components of a knowledge base (a “Corpora”) that is ingested from different structured or unstructured information available to the organization. Moreover, the corpora (or corpus) has itself been “ingested” by a set of pre-processing steps that use NLP (Natural Language Processing) to analyze the content and transform it in a format adapted to the DeepQA Analysis engines. An artificial intelligence (AI) engine, such as the IBM Watson system, that analyzes the data in light of the knowledge base to identify the sensitivity level of the data. Further, based on the sensitivity level identified, the approach performs an appropriate action.

FIG. 3 is a component diagram showing the various components used in evaluating documents and determining appropriate actions to take based on confidential information found in the documents. Knowledge base 300 (also known as a “Corpora”) includes both internal and externally available data sources. As shown, these data sources can include Confidentiality Policies data store 302, Confidential Documents data store 304, Code Names data store 306, Trade Secrets data store 308, Product Specifications data store 310, Products data store 312, Schedules data store 314, Roles, Responsibilities, and Organization Chart data store 316, Rules, Laws, Regulations data store 318, Profanity & Harassment Rules/Guidelines data store 320, as well as other data stores 322.

Data from many different sources, such as email data 325 (e.g., email messages, email attachments, etc.), and documents managed by a Content Management System (CMS) 330 are two sources of data 340. Other sources 335 can include forum postings, instant messages, tweets, meeting notices, and the like. Artificial intelligence (AI) engine 350 is a computer system capable of processing natural language inputs. An example of such an AI engine is the IBM Watson system. When the data is received at the AI engine, the AI engine automatically utilizes an artificial intelligence (AI) engine (e.g. IBM Watston, etc.) to perform advanced language processing on unstructured information using, for example but not limited to, the Unstructured Information Management Architecture framework (UIMA).using pre-existing knowledge base 300, resulting in an identification of sensitivity level 355 that corresponds to data 340.

Confidential data handling agent 360 performs an action on the data based on identified sensitivity level 355. If the data is not confidential, then no action is taken (non-process 370). However, if analysis reveals that the data includes confidential information, then a confidential protection action is taken at process 380.

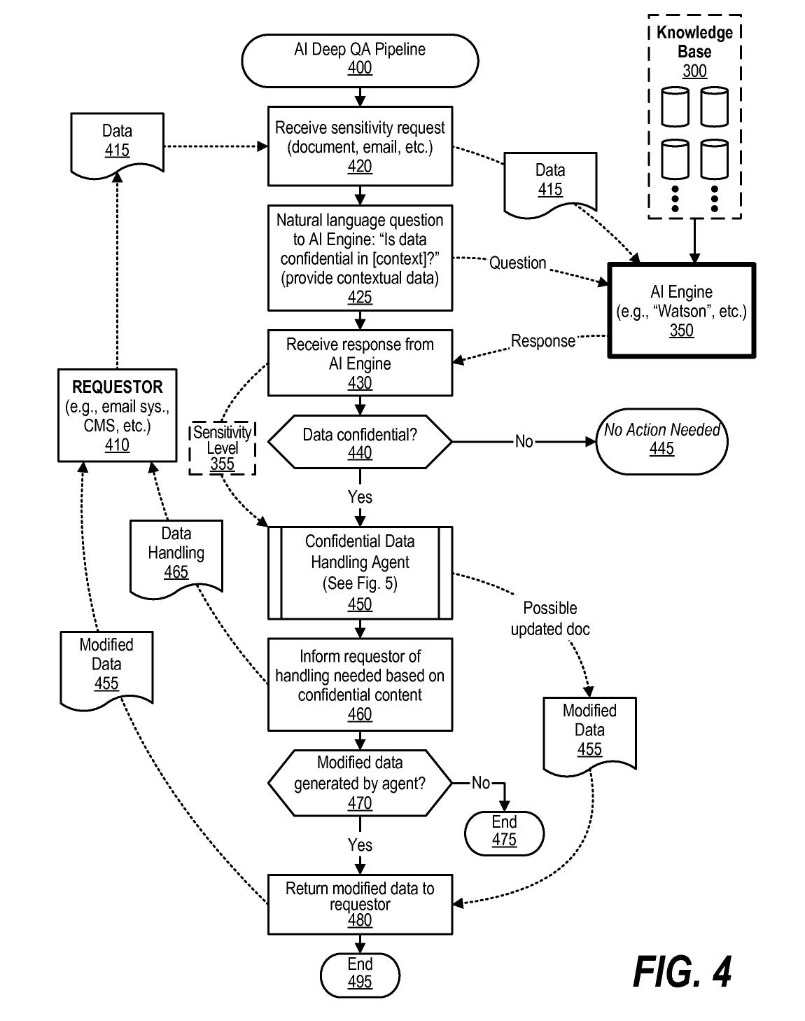

FIG. 4 is a depiction of a flowchart showing the logic used in an artificial intelligence (AI) deep question/answer (QA) pipeline to identify confidential data. Processing comments at 400 whereupon, at step 420, the process receives a sensitivity request to check the sensitivity level of data 415, with data 415 being from requestor 410. Requestor can be a user that submits the data or the requestor can be an automated process, such as a Content Management System (CMS), an email system, a forum management system, etc. Data 415 can be of virtually any form capable of being processed by a computer system, such as email messages and documents (e.g., those managed by a CMS, etc.) forum postings, instant messages, tweets, meeting notices, and the like.

At step 425, a natural language question is posed to AI Engine 350 with the question being essentially, “given the context, what is the sensitivity level of the provided data?” The context can include contextual elements such as the identification of the sender of the data (if the data was intended to be sent in a transmission), the identification of intended recipients of the data, and the context provided by the organization's knowledge base 300, such as the trade secrets, trade names, project names, organizational structure and details, and the like.

At step 430, a response is received from AI Engine with the response including a sensitivity level of the provided data. A decision is made as to whether the sensitivity level indicates that the data includes confidential information (decision 440). If the sensitivity level indicates that the data is void of confidential information, then decision 440 branches to the “no” branch whereupon, at 445, no action is taken on the data. On the other hand, if the sensitivity level indicates that the data includes confidential information, then decision 440 branches to the “yes” branch for further processing.

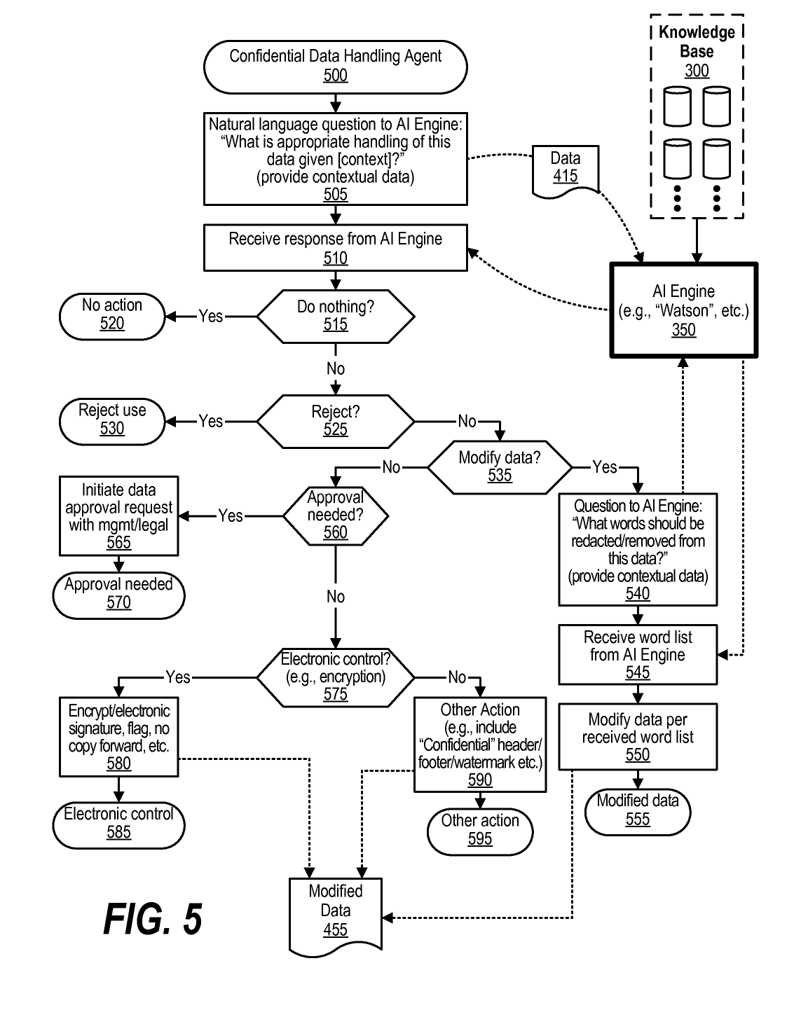

At predefined process 450, a confidential data handling agent is executed on the data given the identified data sensitivity level (see FIG. 5 and corresponding text for processing details). In one embodiment, the confidential data handling agent may alter (e.g., redact, etc.) or otherwise modify the data, in which case predefined process 450 returns updated data 455 (e.g., redacting a project code name, etc.).

At step 460, the process informs requestor 410 of the handling of the data based on the confidential information identified by predefined process 450. In one embodiment, the process informs requestor 410 by transmitting data handling message 465. For example, the data handling message may inform a requestor that the data is not allowed to be sent to a set of intended recipients due to the confidential information included in the data.

A decision is made as to whether the confidential data handling agent modified the data (e.g., redacting certain confidential information, etc.) in decision 470. If the confidential data handling agent did not modify the data, then decision 470 branches to the “no” branch whereupon processing ends at 475. On the other hand, if the confidential data handling agent modified the data, then decision 470 branches to the “yes” branch whereupon, at step 480, modified data 455 is returned to the requestor. In this manner, modified data that protects confidential information in the data is protected by preventing such confidential information to be disseminated to unauthorized individuals (e.g., redacted from an email, tweet, document, etc.). Processing thereafter ends at 495.

FIG. 5 is a depiction of a flowchart showing the logic used in the confidential data handling agent. Processing commences at 500 whereupon, at step 505, a natural language question is posed to AI Engine 350, this time the question posed is “What is the appropriate handling of this data given the context?” Again, the context can include contextual elements such as the identified sensitivity level, the identification of the sender of the data (if the data was intended to be sent in a transmission), the identification of intended recipients of the data, and the context provided by the organization's knowledge base 300, such as the trade secrets, trade names, project names, organizational structure and details, and documents that detail the appropriate handling of the organization's confidential documents. In the case of multiple email recipients, the system automatically computes the appropriate action to take for each recipient of the email. For example, an authorized recipient might receive the actual data, while a recipient without authorization may receive a redacted copy of the email, etc. At step 510, a response is received from AI Engine 350 identifying the action that should be given to the data given the context.

A decision is made as to whether the action is to “do nothing” (decision 515). For example, if confidential data is an email being transmitted from the organization's president to a manager in the organization and the email already includes a statement that the data is confidential, then the AI Engine may not identify any actions to perform. In this case, decision 515 branches to the “yes” branch whereupon no action is taken and processing returns at 520 (e.g., returning a response to the calling routine indicating that no action is needed, etc.). On the other hand, if an action is identified, then decision 515 branches to the “no” branch for further analysis.

A decision is made as to whether the action to take with regard to the data submission is to reject the submission (decision 525). For example, if an unauthorized employee attempts to email the code name of a secret project to a person outside the organization, the action may be to reject the use of the data entirely. In this case, decision 525 branches to the “yes” branch whereupon the intended use of the data is rejected at 530 (e.g., returning a response to the calling routine, such as an email system, indicating that the data should be rejected, etc.). On the other hand, if the action is not to reject the data submission, then decision 525 branches to the “no” branch for further analysis.

A decision is made as to whether the action to take with regard to the data submission is to modify the data (decision 535). For example, if an email reveals the code name of a secret project but is otherwise acceptable, the action may be to redact the code name but otherwise allow the email. In this case, decision 535 branches to the “yes” branch whereupon, at step 540 a question is posed to the AI Engine as to what words and/or phrasing should be modified (e.g., redacted, removed, etc.) from the submitted data. At step 545, a word list is received from the AI Engine and, at step 550, the data is modified based on the words included in the received word list (e.g., removing the name of the code name of a secret project, etc.), resulting in modified data 455. Processing returns to the calling routine at 555 (e.g., returning a response to the calling routine, such as an email system, indicating that modified data 465 should be used in place of the submitted data, etc.). On the other hand, if the action is not to modify the data submission, then decision 535 branches to the “no” branch for further analysis.

A decision is made as to whether the action to take with regard to the data submission is to initiate an approval process, such as with the organization's legal department or with the organization's management (decision 560). For example, if an email is providing a customized level of pricing to a customer, the email could be reviewed by legal/management for approval before it is sent to the customer. If the action is that approval is needed, then decision 560 branches to the “yes” branch whereupon, at step 565, a data approval process is initiated with the appropriate decision makers (e.g., legal department, management, etc.). Processing returns to the calling routine at 570 (e.g., returning a response to the calling routine, such as an email system, indicating that an approval process has been initiated, etc.). On the other hand, if the action is not to request approval, then decision 560 branches to the “no” branch for further analysis.

A decision is made as to whether the action to take with regard to the data submission is to perform any number of electronic controls on the data (decision 575). For example, an email being sent outside the organization by an authorized officer may include confidential data that should be encrypted. If the action is to perform an electronic control, then decision 575 branches to the “yes” branch whereupon, at step 580, the electronic control is performed on the data (e.g., encrypting the document, adding an electronic signature, flagging the document, adding a “no copy forward” designation to the document, etc.), resulting in modified data 455. Processing returns to the calling routine at 585 (e.g., returning a response to the calling routine, such as an email system, indicating that the data has been electronically protected and indicating that modified (encrypted) data 465 should be used in place of the submitted data, etc.). On the other hand, if the action is not an electronic control action, then decision 575 branches to the “no” branch for other actions.

At step 590, other actions may be taken on the data, such as inserting a “confidential” header, footer, or watermark on a document, or by performing any number of other actions with regard to the data. Processing returns to the calling routine at 595 (e.g., returning a response to the calling routine, such as an email system, indicating the other action that was taken, etc.). In cases where the data was modified (e.g., adding a “confidential” header, footer, watermark, etc.), the process also indicates to the calling routine that modified data 465 should be used in place of the submitted data. Based on the submitted data, multiple actions may be performed. For example, data may be modified (e.g., redacted, etc.), have a “confidential” header, footer, or watermark added, and also be encrypted. This can be accomplished by having the calling routine call the Confidential Data Handling Agent repeatedly until the agent does not identify any additional actions to take with respect to the data.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of automatically classifying and handling data, the method, implemented by an information handling system, comprising:
receiving, from a sender, data;
responsive to receiving the data, automatically utilizing an artificial intelligence (AI) engine to perform a natural language processing process on unstructured data using a pre-existing knowledge base, resulting in an identification of a confidentiality level of the data; and
performing an action based on the identified confidentiality level.

2. The method of claim 1 wherein the action is selected from a group consisting of redacting the content, encrypting the content, rejecting the submission, and starting an approval workflow.

3. The method of claim 1 wherein the data exists in a data handling system content selected from a group consisting of an email, an email attachment, a forum posting, a content management posting, an instant message, a tweet, and a meeting notice.

4. The method of claim 1 further comprising:
converting the data to a format suitable for analysis;
analyzing, by the AI engine, the data against the knowledge base;
scoring, by the AI engine, the analysis to identifying the confidentiality level; and
utilizing an organization map of an organization along with the sender and a plurality of receivers to determine the action, wherein the sender is a member of the organization.

5. The method of claim 4 wherein the scoring further comprises:
utilizing machine learning (ML);
retrieving and utilizing ML models; and
interpreting and evaluating a plurality of sources in the knowledge base using an inference engine to provide one or more scores.

6. The method of claim 4 wherein the knowledge base includes one or more sources selected from the group consisting of annotators, sensitive documents, code names, trade secret names, product specifications, products, development schedules, organization maps, organizational charts, organizational responsibilities, profanity, harassment rules, organizational policies, rules, laws, and regulations.

7. The method of claim 1 further comprising:
identifying a plurality of intended receivers of the data; and
wherein the action performed is based on the identified confidentiality level, the sender, and the plurality of receivers.

8. An information handling system comprising:
a plurality of processors;
a memory coupled to at least one of the processors;
a knowledge base stored on a nonvolatile memory accessible by at least one of the processors;
an artificial intelligence (AI) engine executed by one or more of the plurality of processors that performs a natural language processing process on unstructured data using a pre-existing knowledge base; and
a set of instructions stored in the memory and executed by at least one of the processors to automatically classifying and handling data, wherein the set of instructions perform actions of:
receiving, from a sender, data at a content management system;
responsive to receiving the data, automatically utilizing the artificial intelligence (AI) engine to process the data using the pre-existing knowledge base, resulting in an identification of a confidentiality level of the data; and
performing an action based on the identified confidentiality level.

9. The information handling system of claim 8 wherein the action is selected from a group consisting of redacting the content, encrypting the content, rejecting the submission, and starting an approval workflow.

10. The information handling system of claim 8 wherein the data exists in a data handling system content selected from a group consisting of an email, an email attachment, a forum posting, a content management posting, an instant message, a tweet, and a meeting notice.

11. The information handling system of claim 8 further comprising:
converting the data to a format suitable for analysis;
analyzing, by the AI engine, the data against the knowledge base;
scoring, by the AI engine, the analysis to identifying the confidentiality level; and
utilizing an organization map of an organization along with the sender and a plurality of receivers to determine the action, wherein the sender is a member of the organization.

12. The information handling system of claim 8 wherein the set of instructions that perform the scoring includes additional instructions that perform additional actions comprising:
utilizing machine learning (ML);
retrieving and utilizing ML models; and
interpreting and evaluating a plurality of sources in the knowledge base using an inference engine to provide one or more scores.

13. The method of claim 12 wherein the knowledge base includes one or more sources selected from the group consisting of annotators, sensitive documents, code names, trade secret names, product specifications, products, development schedules, organization maps, organizational charts, organizational responsibilities, profanity, harassment rules, organizational policies, rules, laws, and regulations.

14. The information handling system of claim 12 wherein the set of instructions performs additional actions comprising:
identifying a plurality of intended receivers of the data; and
wherein the action performed is based on the identified confidentiality level, the sender, and the plurality of receivers.

15. A computer program product stored in a computer readable medium, comprising computer instructions that, when executed by an information handling system, causes the information handling system to perform actions comprising:
receiving, from a sender, data at a content management system;
identifying a plurality of intended receivers of the data;
responsive to receiving the data, automatically utilizing an artificial intelligence (AI) engine to perform a natural language processing process on unstructured data using a pre-existing knowledge base, resulting in an identification of a confidentiality level of the data; and
performing an action based on the identified confidentiality level, the sender, and the plurality of receivers.

16. The computer program product of claim 15 wherein the action is selected from a group consisting of redacting the content, encrypting the content, rejecting the submission, and starting an approval workflow.

17. The computer program product of claim 15 wherein the data exists in a data handling system content selected from a group consisting of an email, an email attachment, a forum posting, a content management posting, an instant message, a tweet, and a meeting notice.

18. The computer program product of claim 15 wherein the actions further comprise:
converting the data to a format suitable for analysis;
analyzing, by the AI engine, the data against the knowledge base;
scoring, by the AI engine, the analysis to identifying the confidentiality level; and
utilizing an organization map of an organization along with the sender and a plurality of receivers to determine the action, wherein the sender is a member of the organization.

19. The computer program product of claim 18 wherein the scoring further includes additional actions comprising:
utilizing machine learning (ML);
retrieving and utilizing ML models; and
interpreting and evaluating a plurality of sources in the knowledge base using an inference engine to provide one or more scores.

20. The computer program product of claim 18 wherein the knowledge base includes one or more sources selected from the group consisting of annotators, sensitive documents, code names, trade secret names, product specifications, products, development schedules, organization maps, organizational charts, organizational responsibilities, profanity, harassment rules, organizational policies, rules, laws, and regulations.
